(19) United States
(12) Patent Application Publication
(10) Pub. No.: US 2018/0180143 A1
(43) Pub. Date: Jun. 28, 2018

(54) ACTUATOR

(71) Applicant: Goodrich Actuation Systems Limited, Solihull (GB)

(72) Inventors: Andrew HAWKSWORTH, Shropshire (GB); Antony MORGAN, Wolverhampton (GB)

(21) Appl. No.: 15/730,945

(22) Filed: Oct. 12, 2017

(30) Foreign Application Priority Data
Dec. 22, 2016 (EP) 16206401.8

(51) Int. Cl. F16H 25/20; F16F 3/06; F16H 25/22

(52) U.S. Cl. CPC F16H 25/2015; F16H 25/2021; F16H 2025/2031; F16H 25/2204; F16F 3/06

(57) ABSTRACT

A linear actuator comprising: an axially moveable member; a housing within which the axially moveable member is mounted for linear movement relative to the housing; drive means to move the axially moveable member between an extended axial position and a retracted axial position; and one or more springs provided to absorb impact from axial movement of the axially moveable member at the extended axial position and/or at the retracted axial position.

### FOREIGN PRIORITY

This application claims priority to European Patent Application No. 16206401.8 filed Dec. 22, 2016, the entire contents of which is incorporated herein by reference.

### TECHNICAL FIELD

The present disclosure relates to actuators, particularly to linear actuators, most preferably electric or mechanical actuators, but also hydraulic actuators.

### BACKGROUND

Actuators find a very wide range of uses in a wide range of technical fields, for moving or controlling components. As an example, actuators find many applications in the aircraft or aerospace industry. Actuators are used, for example, to move or control operation of control surfaces of an aircraft e.g. to actuate nose wheel steering, elevators, rudders, ailerons etc. Typically, an actuator extends and retracts to allow deployment and retraction of the control system.

A typical actuator comprises an axially moveable member, within a chamber e.g. a cylinder, that is controlled to extend/retract to correspondingly drive the control surface. Actuators are designed to be as light and compact as possible without compromising reliability and safety. Fail-safe features may also be incorporated particularly for ‘flight-critical’ actuators. It is also important to minimise the maintenance requirements for actuators, especially in aircraft, as repair or maintenance is not possible during flight.

Conventional actuators are hydraulically powered. Movement of the axially moveable member or piston is caused by hydraulic fluid introduced into the chamber or cylinder. Valves are provided to control the fluid flow for appropriate control of the actuator. In some systems, the axially moveable member may comprise two pistons, one inside the other, to increase actuator force whilst maintaining a compact design.

More recently, mechanical and electrical actuators have been developed. In the aircraft industry, for example, there is a move towards developing so-called ‘more electric aircraft’ (MEA) whereby components such as hydraulic actuators are being supplemented or replaced by electric actuators. These electric actuators overcome some known disadvantages of hydraulic actuators such as their bulk, the need for seals and grommets, the risk of leaks, the high maintenance requirements, the use of potentially explosive oil in an aircraft etc. but they also present their own challenges.

Large forces and speeds can be generated in actuation systems, and high inertial masses can be created. This can create problems at the ends of the actuator stroke, where the moveable member can impact the end of the cylinder with a high inertial mass/force. This can cause undesirable jarring and also undesirable wear or even damage to the actuation system. It is known, therefore, in hydraulic actuators, to provide some form of damping at the ends of the stroke, e.g. in the form of end stops, cushioning or fluid compression and snubbing techniques to absorb the impact or inertial mass.

Providing damping for electric or mechanical actuators, though, presents a challenge as such systems do not allow for the simple use of hydraulic damping e.g. using hydraulic snubbing techniques. Also, because electric actuators use a smaller motor at high speed, to keep the size of the system down, the resulting inertial mass tends to be a magnitude higher than in hydraulic actuator systems, so more effective damping is required. It is possible to electrically slow the system down as it approaches end of stroke; however, this is complex and unreliable as it requires the system to always know, accurately, e.g. by means of a feedback loop, exactly where the axially moveable member is in its stroke and how fast it is moving to be able to slow down to avoid the impact at the end of stroke.

There is, therefore, a need for improved damping of linear actuators, especially electric actuators, but also other forms of actuator including hydraulic actuators.

### SUMMARY

Accordingly, there is provided a linear actuator comprising: an axially moveable member, a housing within which the axially moveable member is mounted for linear movement relative to the housing; drive means to move the axially moveable member between an extended axial position and a retracted axial position; and one or more springs provided to absorb impact from axial movement of the axially moveable member at the extended axial position and/or at the retracted axial position.

The drive means may be e.g. mechanical, electrical or hydraulic.

The axially moveable member may be provided as a first axially moveable member mounted and axially moveable relative to a second axially moveable member.

Preferably, a spring is mounted at each end of the axially moveable member and if the axially moveable member comprises a first axially moveable member mounted and axially moveable relative to a second axially moveable member, then at the ends of each of the first and second axially moveable member.

The springs are preferably in the form of friction springs such as those available under the Trade Name Ringfeder friction springs also known as ‘Feder rings’.

### BRIEF DESCRIPTION OF THE DRAWINGS

FIG. 1 is a cross-sectional view of an actuator according to the disclosure.

FIG. 2 is a detail view of a damping arrangement of the disclosure with the actuator in a stowed/stowing position.

FIG. 3 is a detail view of a damping arrangement of the disclosure with the actuator in a deploy/deploying position.

FIG. 4 is a simplified view of an example spring.

FIG. 5 shows how the spring force of a spring such as in FIG. 4 varies on application of a load.

### DETAILED DESCRIPTION

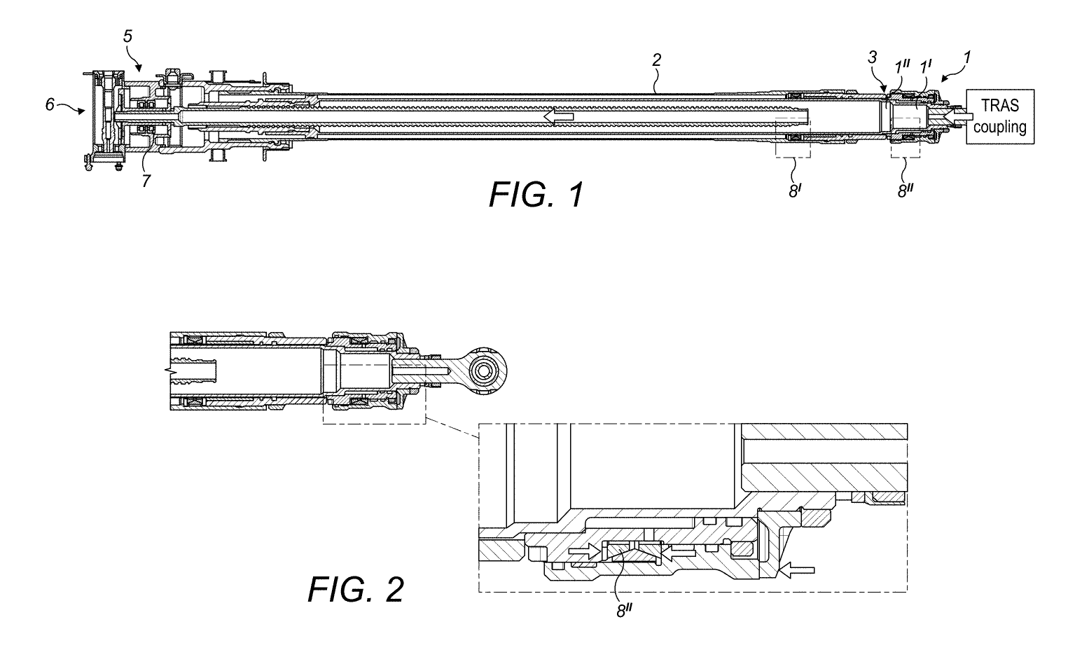

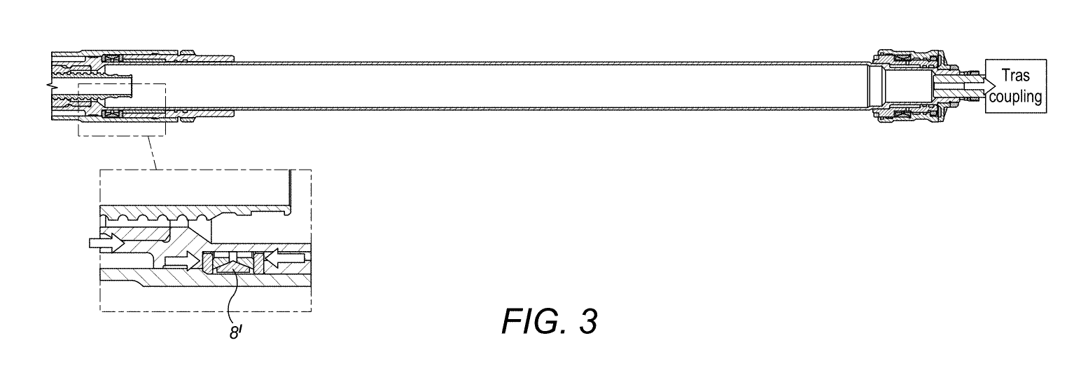

Referring first to FIG. 1, an electric actuator is shown comprising an axially moveable member 1 mounted within a cylinder 2. The axially moveable member is arranged to move axially or linearly with respect to the cylinder to extend from and retract into the open end 3 of the cylinder 2. The end of the axially moveable member at the open end of the cylinder is coupled to or arranged to be coupled to the component or surface to be moved, by connecting means e.g. an eye-bolt. In the example shown, the axially moveable member 1 comprises two rods, one 1′ inside the other 1″. A single rod could also be used.

Movement of the axially moveable member 1 is controlled by an electric motor input 5 controlled by a motor controller. The motor and motor controller can be of any known type and is mounted upstream of input 5. For a hydraulic actuator, the motor and motor controller would be replaced by any known hydraulic supply and control arrangement to cause movement of the axially moveable member by hydraulic fluid pressure. Gearing, such as ball screw gearing 7 may be provided to translate rotary motion of the rotor 5 to linear motion of the axially moveable member 1. Here, a right angle gear box 7a rotates screw 7 providing gearing to nut 7b transferring torque to linear motion of the axially moveable member 1.

The axially moveable member 1 moves between a deploy position and a stow position. These positions will vary depending on the application. As an example, such actuators may be used in a RAT or TRAS system of an aircraft, wherein, as shown, the retracted position of the axially moveable member is the deploy position and the extended position is the stow position. In other applications, the stow and deploy positions may be the retracted and extended positions respectively. In these respective positions, a stop or end surface prevents further axial movement in that direction.

As mentioned above, a high inertial mass can be created by the movement of the member, which can cause the member to crash against the stop with high impact. This can cause damage and/or wear to the assembly components.

To avoid or mitigate such impact, the actuator of the present disclosure incorporates one or more friction springs 8′, 8″ axially positioned with respect to the axially moveable member and positioned between the axially moveable member and the respective stops or ends to absorb the impact.

Preferably, a friction spring is provided at each of the deploy (8′) and stow (8″) positions, but advantages are obtained even with a spring at only one of those locations.

In the example shown, where the axially moveable member comprises an inner and an outer rod, it is also possible to provide four such springs at the two extremes of movement of each rod.

Whilst any springs would reduce impact, friction springs are preferred as a large amount of energy is generated by the friction caused by movement of the axially moveable member. The friction springs act to absorb a large amount of energy within a small volume.

The friction springs are preferably fully sealed within the actuator to ensure consistent lubrication and good protection against external foreign bodies. Further, the incorporation of springs into existing actuators e.g. TRAS, is simple and the springs can be tuned to meet the required energy absorption.

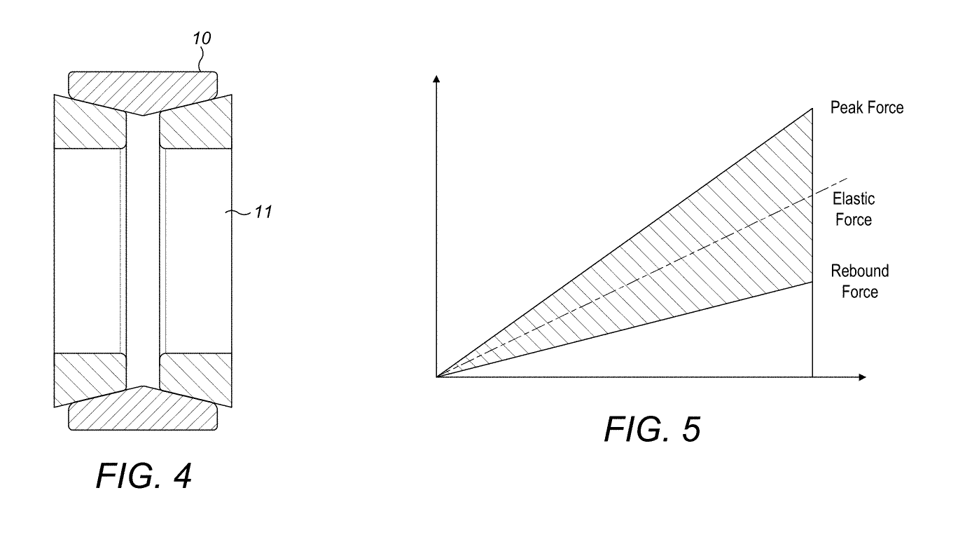

Most preferably, the system uses friction springs such as Ringfeder™ friction springs (also known as ‘Feder rings’). As shown in FIG. 4, such a spring consists of a series of separate inner 11 and outer 10 rings with mating taper faces. Under the application of an axial load, the wedge action of the taper faces expands the outer rings and contracts the inner rings radially allowing axial deflection.

Friction and hoop stresses between the rings allows the axial force to be elevated to the peak force and the subsequent rebound force is also lower, as shown in FIG. 5, thus the ringfeders are both springs and dampers.

The friction springs absorb drive motor kinetic energy to ensure excessive torque being experienced by internal gears of the system.

Such springs could also be incorporated in hydraulic actuators to supplement or replace existing damping.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A linear actuator comprising:
an axially moveable member;
a housing within which the axially moveable member is mounted for linear movement relative to the housing;
drive means to move the axially moveable member between an extended axial position and a retracted axial position; and
one or more springs provided to absorb impact from axial movement of the axially moveable member at the extended axial position and/or at the retracted axial position.

2. The actuator of claim 1 wherein the drive means is one of mechanical, electrical or hydraulic.

3. The actuator of claim 1, wherein the axially moveable member is provided as a first axially moveable member mounted and axially moveable relative to a second axially moveable member.

4. The actuator of claim 1, wherein the one or more springs comprises a spring mounted at each end of the axially moveable member.

5. The actuator of claim 3, wherein the one or more springs comprises a spring at each end of each of the first and second axially moveable member.

6. The actuator of claim 1, wherein the one or more springs comprise friction springs.

7. The actuator of claim 6, wherein the friction springs comprise Ringfeder™ friction springs.
